(19) United States
(12) Patent Application Publication
(10) Pub. No.: US 2013/0320094 A1
(43) Pub. Date: Dec. 5, 2013

(54) DYNAMIC EMBEDDED MACHINE READABLE ENCODING

(71) Applicants: Mark Slusar, Chicago, IL (US); Ken Prchal, Seattle, WA (US)

(72) Inventors: Mark Slusar, Chicago, IL (US); Ken Prchal, Seattle, WA (US)

(21) Appl. No.: 13/483,696

(22) Filed: May 30, 2012

(51) Int. Cl. G06K 19/00

(52) U.S. Cl. 235/487

(57) ABSTRACT

The disclosed embodiments relate to objects, such as images, e.g. posters, maps, etc., augmented with machine readable indicia, such as optically readable codes, where the machine readable indicia are arranged in manner on at least a portion of the object such that different indicia may be perceptible to a suitably configured device, e.g. a suitably programmed camera phone, dependent upon the relationship of the device to the portion of the object.

### BACKGROUND

With the increase in popularity of smart phones and other portable electronic devices which feature cameras or other image processing capabilities, the use of machine readable indicia, such as bar codes or QR codes, on signage, product labels, print media, etc., to convey additional information or to refer a user to additional sources of information, has also increased. The user of a suitable portable electronic device merely scans or otherwise takes a picture of the machine readable code with their device and, using a suitable application program which may be provided therewith, the device presents, e.g. displays, the additional information or otherwise accesses the additional sources of information.

In some implementations, such machine readable codes may be presented on their own, in conjunction with, e.g. adjacent to or included among, human readable/comprehensible content, such as a map, advertisement or picture, or as a watermark embedded therein, and which may or may not be visible to a human observer.

On their own, machine readable indicia are of limited value without a suitable device which can read them. A machine readable indicia implemented in conjunction with human readable/comprehensible content provides substantially more utility as, without a suitable device, at least the user can utilize the human readable/comprehensible content. However, the relatively static nature of their implementation further limits their usefulness.

### BRIEF DESCRIPTION OF THE DRAWINGS

FIG. 1 is a block diagram of an exemplary implementation of the system.

FIG. 2 depicts a flow chart showing operation of the system of FIG. 1.

FIG. 3 shows an illustrative embodiment of a general computer system for use with the system of FIG. 1.

FIG. 4 depicts a block diagram of an exemplary object according to the disclosed embodiments.

### DETAILED DESCRIPTION

The disclosed embodiments relate to the creation of a dynamic interactive experience for a user. In particular, the disclosed embodiments relate to objects, such as images, e.g. posters, maps, etc., augmented with machine readable indicia, such as optically readable codes, where the machine readable indicia are arranged in manner on at least a portion of the object such that different indicia may be perceptible to a suitably configured device, e.g. a suitably programmed camera phone, dependent upon the relationship of the device to the same portion of the object.

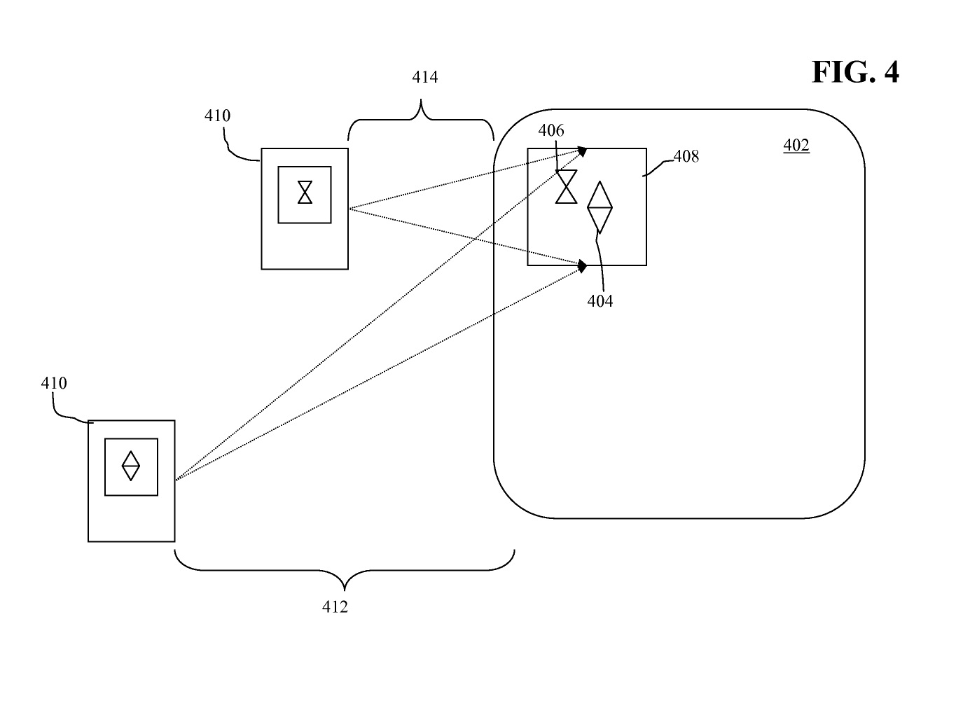

For example, as shown in FIG. 4, a poster of a map, or other object, 402 may be augmented with multiple machine readable indicia 404 406, e.g. bar codes, QR codes or other markings as will be described, placed at a particular location 408 on the map/object 402 such that when a user (not shown) scans, or otherwise takes a picture of, at least the portion 408 of the object 402 with their camera phone or other suitable device 410 from, for example, a first distance or range 412, e.g. 10 feet away, the camera phone/device 410 is able to read one of the machine readable indicia 404, e.g. encoding some general information about the represented geographic area, but is otherwise unable to read another machine readable indicia 406 placed at the location 408. However, when the user moves to closer distance or range 414 from the object 402, e.g. 2 feet away, the camera phone/device 410 is able to read the other machine readable indicia 406 placed at the same, or substantially the same, location 408 on the map/object 402 which may encode different information, such as more detailed information about the represented geographic area.

In another example, a sculpture or other three dimensional object 402 may feature a portion 408 which is augmented with multiple machine readable indicia 404 406, e.g. bar codes, QR codes or other markings as will be described, such that a particular machine readable indicia is readable only when the user holds their device 410 substantially at a particular position 412 414, or range thereof, around the sculpture/object 402.

The disclosed embodiments may be utilized to provide different information to a user, via their device 410, depending upon where they, or their device 410, are physically located, or otherwise oriented, with respect to an object. Furthermore, the disclosed embodiments may be utilized to force a user to be in a certain location or vicinity, or otherwise substantially orient their device in a particular orientation, in order to obtain certain information or otherwise to know that a user is in a certain location or vicinity thereof, or otherwise has their device substantially in a certain orientation, based on the knowledge that the information is only accessible from a defined location and/or when a device is in a defined orientation. For example, the machine readable indicia, which is readable only from a particular range of locations, may encode a URL or other code such that when the user's device 410, for example, accesses the URL, the web site is substantially assured that the user and/or their device 410 is positioned at the desired location. Accordingly, the disclosed embodiments may be utilized to provide an dynamic user experience and/or location based services or information, such as geo-relevant information, positional based authentication, etc. Furthermore, the disclosed embodiments may be more useful than other techniques for delivering location based services, such as geo-fencing or using other locating technologies such as GPS, aGPS, Wifi, etc. to determine the device position, as the disclosed embodiments are not dependent upon being able to receive a GPS or Wifi signal and, as such, may be more functional, for example, within enclosed structures such as office buildings, shopping malls, underground train stations and tunnels and the like. Furthermore, the disclosed embodiments may facilitate more precise locating functionality than may be obtained using GPS, aGPS and/or Wifi enabling, for example, micro-location based services. Of course, it will be appreciated that the disclosed embodiments may be utilized in conjunction with other locating based technologies so as to further enhance the capabilities described herein.

More generally, as will be described in more detail below, in one embodiment, an object 402 is provided, at least a portion 408 of which comprises a first machine readable indicia 404 representative of first information and second machine readable indicia 406 representative of second information different from the first information. The first machine readable indicia is provided or otherwise presented such that it is perceptible to, i.e. readable or otherwise comprehendible by, a device 410, the device 410 being capable, as will be described, of reading/comprehending both the first and second machine readable indicia 404 406 to obtain the first and second information represented thereby, when the device 410 is arranged in a first relationship 412 with respect to the portion 408 of the object 402. The second machine readable indicia 406 is presented or otherwise provided such that it is perceptible to the device 410 when the device 410 is arranged in a second relationship 414 with respect to the same portion 408 of the object 402, the second relationship 414 being different from the first relationship 412. Wherein the second machine readable indicia 406 is not perceptible to the device 410 when the device 410 is arranged in the first relationship 412 and the first machine readable indicia 404 is not perceptible to the device 410 when the device 410 is arranged in the second relationship 414.

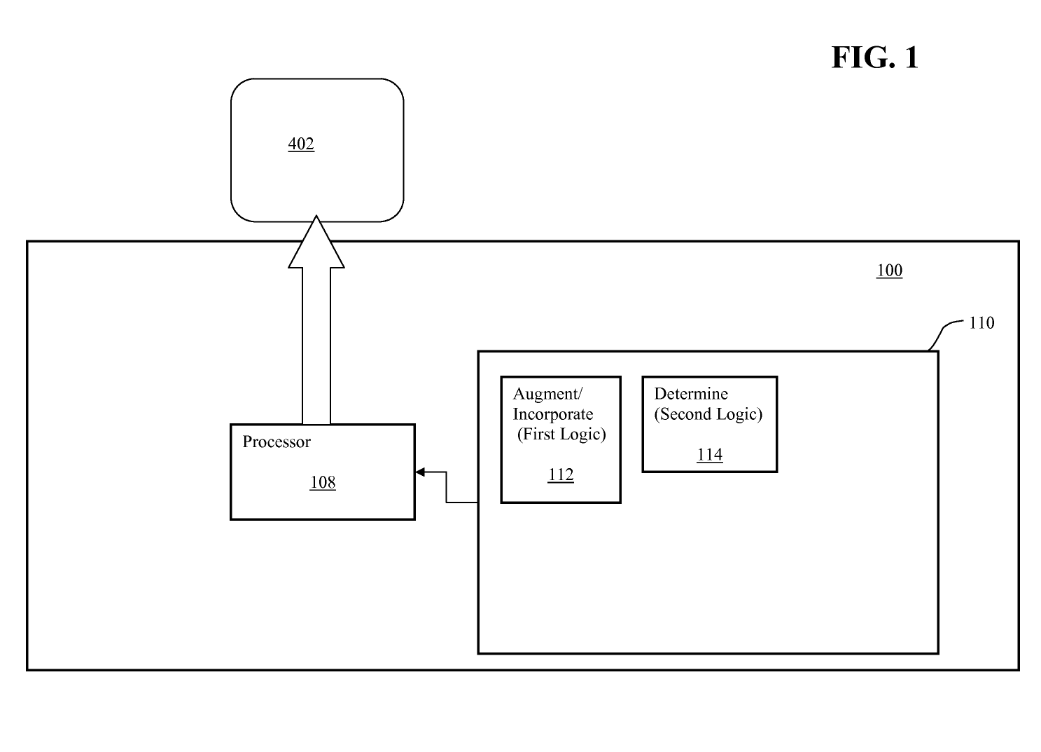

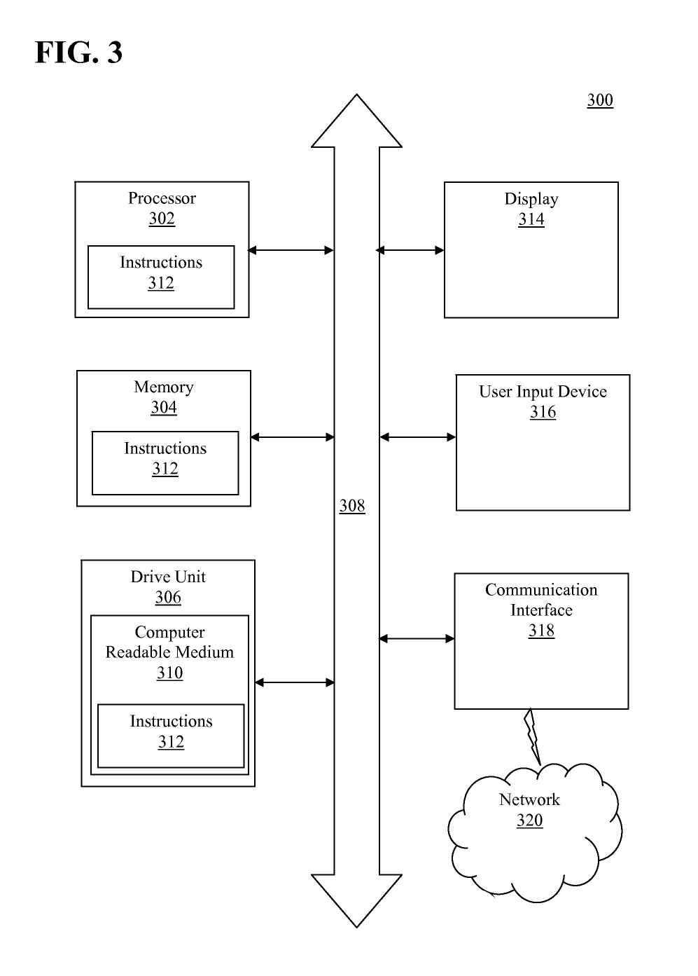

FIG. 1 shows a system 100 according to one embodiment, to augment at least a portion 408 of an object 402 with multiple machine readable indicia 404 406 as described above. The system 100 includes a processor 108 and a memory 110 coupled therewith which may be implemented by one or more of the processor 302 and memory 304 as described below with respect to FIG. 3. In particular, the system 100 may be implemented, at least in part, by one or more of the computer 300, as described below, coupled with a device such as a printer, etcher, imprinter, or other such device, to generate an object 402 having the machine readable indicia 404 406 appearing or otherwise presented thereon, as described herein, or to otherwise generate other output, such as a sticker, overlay or other augmentation object, which may be affixed to an object 402 to provide the object 402 with the machine readable indicia 404 406 as described herein. Wherein the object 402 comprises an image, static or dynamic, electronically presented on a display, such as a display 314 described below, or otherwise projected thereby, the system 100 may be implemented so as to be able to augment the electronic image, at the time the image is created, as stored or at the time of display/presentation, to include the requisite machine readable indicia 404 406 or otherwise augment the presentation thereof on the display 314, or projection thereof, to include the machine readable indicia 404 406. It will be appreciated that the source, or creation of the object 402, may be implemented or otherwise executed by a system, a process or entity independent of, or coupled or otherwise associated with, the system 100 or the operating entity thereof. Further, the creation of the machine readable indicia 404 406 and/or the information represented and/or referenced thereby, may be executed by a system, a process or entity independent of, or coupled or otherwise associated with the system 100 or the operating entity thereof.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The system 100 further includes first logic 112 stored in the memory 110 and executable by the processor 108 to cause the processor 108 to augment at least a portion 408 of an object 402 to include a first machine readable indicia 404 representative of first information and second machine readable indicia 406 representative of second information different from the first information, such that the first machine readable indicia 404 is perceptible to a device 410, the device being capable of reading both the first and second machine readable indicia 404 406 to obtain the first and second information represented thereby, when the device 410 is arranged in a first relationship 412 with respect to the portion 408 of the object 402 and the second machine readable indicia 406 is perceptible to the device 410 when the device 410 is arranged in a second relationship 414 with respect to the portion 408 of the object 402, the second relationship 414 being different from the first relationship 412 and wherein the second machine readable indicia 406 is not perceptible to the device 410 when the device 410 is arranged in the first relationship 412 and the first machine readable indicia 404 is not perceptible to the device 410 when the device 410 is arranged in the second relationship.

The device 410 may comprise any suitable device having the capability to perceive and interpret the first and second machine readable indicia 404 406. In one embodiment, the device 410 is a smart phone or camera phone which includes suitable software for perceiving and acting on the machine readable indicia 404 406. In an alternative embodiment, the device 410 may be a proprietary device suitable for use with the disclosed embodiments. For example, a museum may distribute or loan proprietary devices 410 for use by patrons to view exhibits and access information.

In one embodiment, the object 402 may be an image, statically or dynamically presented or printed, a sculpture, or a model, or otherwise embodied in a physical medium. For example, the object 402 may be a poster, such as a poster of a geographic map, or an electronically displayed or projected representation thereof. The object 402 may comprises a series or sequence of static presentations. The object 402 may be a sculpture or model or other three dimensional object for which an observer may observe the object 402 from different angles or orientations. The object 402 may be mounted or otherwise presented in various orientations, e.g. vertically, such as mounted to, displayed or projected on a wall, or horizontally, such as placed, displayed or projected on a table or pedestal.

In one embodiment, the first and/or second information encoded by the first and second machine readable indicia 404 406 reference additional information sources and may include uniform resource locators, postal addresses, telephone numbers, email addresses, twitter handles, instant messaging identifiers and the like. Using references to information, rather than the information itself, may allow for more information to be provided than can be encoded in the indicia, allow for dynamic or customized information to be provided and/or simply allow simplified modification/maintenance thereof. Alternatively, or in addition thereto, the first and/or second information may include non-referential information such as factual information or other data. It will also be appreciated that the first and/or second information may include executable code, a directive or a command which cause the device 410 to take some form of action, such as prompt the user, take a picture, play a sound, launch an app., etc. The executable code may include an entire application program. It will be appreciated that the nature of the first and second information is limited only by the data density of the particular machine readable indicia format which is utilized and is implementation dependent.

In one embodiment, the first and/or second machine readable indicia 404 406 may be markings, such as optically readable indicia, e.g. bar codes, QR codes or other optically perceptible machine readable indicia. It will be appreciated that the machine readable indicia 404 406 may or may not be visible or otherwise substantially perceptible to a human observer. For example, the first and/or second machine readable indicia may comprise ultraviolet (“UV”) ink or a watermark embedded, for example, in an image.

In one embodiment, the first machine readable indicia 404 may characterized by a representation, e.g. size, resolution, sharpness, color, or combination thereof, resolvable by an optical sensor of the device 410 at a first distance, or range thereof, from, and/or in a first orientation, or range thereof, with respect to, 412 the portion 408 of the object 402 and the second machine readable indicia 406 may be characterized by a representation, e.g. size, resolution, sharpness, color, or combination thereof, resolvable by the optical sensor of the device 410 at a second distance, or range thereof, from, and/or second orientation, or range thereof, with respect to, 414 the portion 408 of the object 402, different, e.g. closer, than the first distance or orientations. It will be appreciated that the nature of the presentation of the machine readable indicia 404 406 may be dependent upon the expected capabilities o the devices 410 that users will be using to read the indicia 404 406, such as the camera resolution and/or focal length or capability to read UV ink, and further dependent upon the desired marginal variation/flexibility in the relationships 412 414 necessary to perceive the indicia 404 406.

Alternatively, or in addition thereto, the first and second machine readable indicia 404 406 may be implemented as one or more optically perceptible markings, e.g. artifacts, such as shapes or icons, or relationships there between. Alternatively, or in addition thereto, the first and second machine readable indicia 404 406 may be implemented as a single indicia, e.g. embedded within one another, wherein, depending upon the relationship between the device 410 and the portion 408 of the object 402, the single indicia may be perceived in a different manner, such as via an optical illusion, forced perspective, etc. For example, the perception of distance between two or three markings, placed a particular locations on the object, may vary depending upon the perspective from which the markings are perceived by the device 410, the perceived distance comprising the first or second machine readable indicia 404 406. That is, depending upon the relationship between the device 410 and the object 402, artifacts/markings disparately presented on the object 402 may appear close together, e.g. they may optically coalesce, or far apart. For example, three markings/artifacts may be placed in a triangular relationship on the object such that, dependent upon the steepness of the angle at which the three markings are viewed, the triangle may appear more or less flatter wherein the degree of perceived flatness of the triangle formed by the three markings comprises the indicia.

In one embodiment, the first logic 112 is further executable by the processor 108 to cause the processor 108 to incorporate a set of markings, e.g. three markings, into the portion 408 of the object 402 wherein the markings as observed by the device 410 in the first relationship 412, e.g. a triangular arrangement having a first perceived degree of flatness, comprise the first machine readable indicia 404 and the set of markings as observed by the device 410 in the second relationship 414, e.g. a triangular arrangement having a second and different perceived degree of flatness, comprise the second machine readable indicia 406.

It will be appreciated that other machine readable indicia, optically readable or otherwise, such as RFID or other audible or radio based signal, the perceptibility or comprehensibility of which may be suitably limited based on the relationship to the device 410 as describe herein, may be also be used. For example, unidirectional and/or controlled range radio signals may be utilized.

In one embodiment, the first and second relationships 412 414 comprise an angle, or range thereof, of the device 410 with respect to the portion 408 of the object 402, a distance, or range thereof, between the device 410 and the portion 408 of the object 402, an orientation, or range thereof, of the device 410 with respect to the portion 408 of the object 402, a rate of change of the angle, the distance or the orientation of the device 410 with respect to the portion 408 of the object 402, or combinations thereof. It will be appreciated that one or both of the device 410 or object 402 may change, e.g. change position and/or orientation, so as to effect a change from the first relationship 412 to the second relationship 414. It will further be appreciated that the precise nature of the relationships 412 414 may depend upon the implementation, e.g. a security implementation may require substantially precise positioning, or narrow range, whereas a guidebook implementation may allow for more flexible positioning, or broader range.

In one embodiment, the first machine readable indicia 404 may be located at a first location on the portion 408 of the object 402 optically perceptible by an optical sensor of the device 410 when the device 410 is arranged in the first relationship 412 and the second machine readable indicia 406 is located at a second location on the portion 408 of the object 402, different from the first location, optically perceptible by the optical sensor of the device 410 when the device 410 is arranged in the second relationship 414. For example, a sculpture or other three dimensional object 402 may feature first and second machine readable indicia 404 406 arranged so that when a user stands in one location and uses their device 410 to observe the portion 408 of the object 402 the device 410 perceives the first machine readable indicia 403 and when the user stands in another location and uses their device to observe the same portion 408 of the object 402, the device 410 perceives the second machine readable indicia 406. This may be useful to provide different information to a user depending on where they are standing.

In one embodiment, the system 100 may further include second logic 114 stored in the memory 110 and executable by the processor 108 to cause the processor 108 to determine at least one desired physical location of a user of the device 410, and/or orientation thereof, with respect to the portion 408 of the object 402 and compute the location and/or orientation of at least one of the first and second machine readable indicia 404 406 such that the respective of the first and second relationships 412 414 comprise the desired physical location.

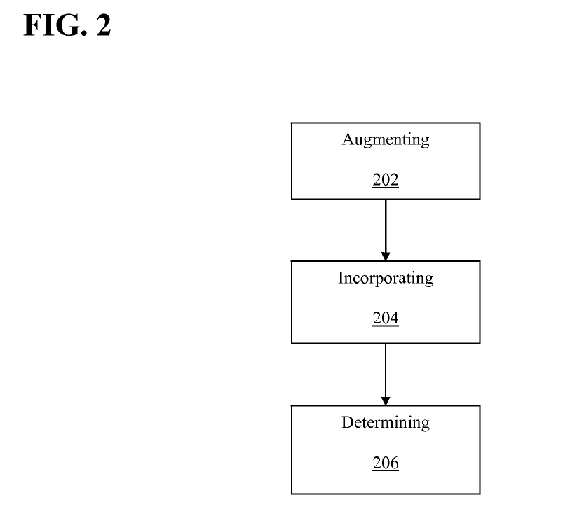

FIG. 2 depicts a flow chart showing operation of the system 100 of FIG. 1. In particular FIG. 2 shows a computer implemented for augmenting at least a portion 408 of an object 410 with multiple machine readable indicia 404 406 as described above, such as via imprinting, etching, affixing, or otherwise modifying the portion 408 of the object 410, or presentation or appearance thereof. It will be appreciated that the source, or creation of the object 402, may be implemented or otherwise executed by a system, process or entity independent of, or coupled or otherwise associated with, the system 100 or the operating entity thereof. Further, the creation of the machine readable indicia 404 406 and/or the information represented and/or referenced thereby, may be executed by a system, a process or entity independent of, or coupled or otherwise associated with the system 100 or the operating entity thereof.

The operation of the system 100 further includes augmenting at least a portion 408 of an object 402 to include a first machine readable indicia 404 representative of first information and second machine readable indicia 406 representative of second information different from the first information, such that the first machine readable indicia 404 is perceptible to a device 410, the device being capable of reading both the first and second machine readable indicia 404 406 to obtain the first and second information represented thereby, when the device 410 is arranged in a first relationship 412 with respect to the portion 408 of the object 402 and the second machine readable indicia 406 is perceptible to the device 410 when the device 410 is arranged in a second relationship 414 with respect to the portion 408 of the object 402, the second relationship 414 being different from the first relationship 412 and wherein the second machine readable indicia 406 is not perceptible to the device 410 when the device 410 is arranged in the first relationship 412 and the first machine readable indicia 404 is not perceptible to the device 410 when the device 410 is arranged in the second relationship [block 202].

In one embodiment, the operation of the system 100 further includes incorporating a set of markings into the portion 408 of the object 402 wherein the markings as observed by the device 410 in the first relationship 412 comprise the first machine readable indicia 404 and the set of markings as observed by the device 410 in the second relationship 414 comprise the second machine readable indicia 406 [block 204].

In one embodiment, the operation of the system 100 may further include determining at least one desired physical location of a user of the device 410, and/or orientation thereof, with respect to the portion 408 of the object 402 and compute the location and/or orientation of at least one of the first and second machine readable indicia 404 406 such that the respective of the first and second relationships 412 414 comprise the desired physical location [block 206].

Referring to FIG. 3, an illustrative embodiment of a general computer system 300 is shown. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices. Any of the components discussed above, such as the processor 108, may be a computer system 300 or a component in the computer system 300. The computer system 300 may implement a location based services system, of which the disclosed embodiments are a component thereof.

In a networked deployment, the computer system 300 may operate in the capacity of a server or as a client user computer in a client-server user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 304 includes a cache or random access memory for the processor 302. In alternative embodiments, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the programmed processor 302 executing the instructions 312 stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 300 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 302, or specifically as an interface with the software stored in the memory 304 or in the drive unit 306. A tactile output may further be provides such a mechanical or piezoelectric vibration motor.

Additionally, the computer system 300 may include an input device 316 configured to allow a user to interact with any of the components of system 300. The input device 316 may be a number pad, a keyboard, or a cursor control device, such as a mouse, or a joystick, touch screen display, remote control, accelerometer, motion sensor, proximity sensor, optional sensor, e.g. a camera, or any other device operative to interact with the system 300.

In a particular embodiment, as depicted in FIG. 3, the computer system 300 may also include a disk or optical drive unit 306. The disk drive unit 306 may include a computer-readable medium 310 in which one or more sets of instructions 312, e.g. software, can be embedded. Further, the instructions 312 may embody one or more of the methods or logic as described herein. In a particular embodiment, the instructions 312 may reside completely, or at least partially, within the memory 304 and/or within the processor 302 during execution by the computer system 300. The memory 304 and the processor 302 also may include computer-readable media as discussed above.

The present disclosure contemplates a computer-readable medium that includes instructions 312 or receives and executes instructions 312 responsive to a propagated signal, so that a device connected to a network 320 can communicate voice, video, audio, images or any other data over the network 320. Further, the instructions 312 may be transmitted or received over the network 320 via a communication interface 318. The communication interface 318 may be a part of the processor 302 or may be a separate component. The communication interface 318 may be created in software or may be a physical connection in hardware. The communication interface 318 is configured to connect with a network 320, external media, the display 314, or any other components in system 300, or combinations thereof. The connection with the network 320 may be a physical connection, such as a wired Ethernet connection or may be established wirelessly as discussed below. Likewise, the additional connections with other components of the system 300 may be physical connections or may be established wirelessly.

The network 320 may include wired networks, wireless networks, or combinations thereof. The wireless network may be a cellular telephone network, an 802.11, 802.16, 802.20, or WiMax network. Further, the network 320 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single non-transitory medium, the term “computer-readable medium” includes a single non-transitory medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method comprising:
augmenting at least a portion of an object to include a first machine readable indicia representative of first information and second machine readable indicia representative of second information different from the first information, such that the first machine readable indicia is perceptible to a device, the device being capable of reading both the first and second machine readable indicia to obtain the first and second information represented thereby, when the device is arranged in a first relationship with respect to the portion of the object and the second machine readable indicia is perceptible to the device when the device is arranged in a second relationship with respect to the portion of the object, the second relationship being different from the first relationship and wherein the second machine readable indicia is not perceptible to the device when the device is arranged in the first relationship and the first machine readable indicia is not perceptible to the device when the device is arranged in the second relationship.

2. The computer implemented method of claim 1 wherein the object comprises one of an image, a sculpture, or a model.

3. The computer implemented method of claim 1 wherein the object is static.

4. The computer implemented method of claim 1 wherein the object is embodied in a physical medium.

5. The computer implemented method of claim 1 wherein the first and second relationships comprise an angle of the device with respect to the portion of the object, a distance between the device and the portion of the object, an orientation of the device with respect to the portion of the object, a rate of change of the angle, the distance or the orientation of the device with respect to the portion of the object, or combinations thereof.

6. The computer implemented method of claim 1 wherein the augmenting further comprises incorporating a set of markings into the portion of the object wherein the markings as observed by the device arranged in the first relationship comprise the first machine readable indicia and the set of markings as observed by the device arranged in the second relationship comprise the second machine readable indicia.

7. The computer implemented method of claim 1 wherein the first machine readable indicia is characterized by a representation resolvable by an optical sensor of the device at a first distance from the portion of the object and the second machine readable indicia is characterized by a representation resolvable by the optical sensor of the device at a second distance from the portion of the object closer than the first distance.

8. The computer implemented method of claim 1 wherein the first machine readable indicia is located at a first location on the portion of the object optically perceptible by an optical sensor of the device when the device is arranged in the first relationship and the second machine readable indicia is located at a second location on the portion of the object, different from the first location, optically perceptible by the optical sensor of the device when the device is arranged in the second relationship.

9. The computer implemented method of claim 1 further comprising:
determining at least one desired physical location of a user of the device with respect to the portion of the object and computing the location of at least one of the first and second machine readable indicia such that the respective of the first and second relationships comprises the desired physical location.

10. A system comprising:
a processor and a memory coupled therewith; and
first logic stored in the memory and executable by the processor to cause the processor to augment at least a portion of an object to include a first machine readable indicia representative of first information and second machine readable indicia representative of second information different from the first information, such that the first machine readable indicia is perceptible to a device, the device being capable of reading both the first and second machine readable indicia to obtain the first and second information represented thereby, when the device is arranged in a first relationship with respect to the portion of the object and the second machine readable indicia is perceptible to the device when the device is arranged in a second relationship with respect to the portion of the object, the second relationship being different from the first relationship and wherein the second machine readable indicia is not perceptible to the device when the device is arranged in the first relationship and the first machine readable indicia is not perceptible to the device when the device is arranged in the second relationship.

11. The system of claim 10 wherein the object comprises one of an image, a sculpture, or a model.

12. The system of claim 10 wherein the object is static.

13. The system of claim 10 wherein the object is embodied in a physical medium.

14. The system of claim 10 wherein the first and second relationships comprise an angle of the device with respect to the portion of the object, a distance between the device and the portion of the object, an orientation of the device with respect to the portion of the object, a rate of change of the angle, the distance or the orientation of the device with respect to the portion of the object, or combinations thereof.

15. The system of claim 10 wherein the first logic is further executable by the processor to cause the processor to incorporate a set of markings into the portion of the object wherein the markings as observed by the device in the first relationship comprise the first machine readable indicia and the set of markings as observed by the device in the second relationship comprise the second machine readable indicia.

16. The system of claim 10 wherein the first and second machine readable indicia each comprise an optically readable code, an optically perceptible artifact, or a combination thereof.

17. The system of claim 10 wherein the first machine readable indicia is located at a first location on the portion of the object optically perceptible by an optical sensor of the device when the device is arranged in the first relationship and the second machine readable indicia is located at a second location on the portion of the object, different from the first location, optically perceptible by the optical sensor of the device when the device is arranged in the second relationship.

18. The system of claim 10 wherein the first information comprises a reference to third information and the second information comprises a reference to fourth information.

19. The system of claim 10 further comprising:
second logic stored in the memory and executable by the processor to cause the processor to determine at least one desired physical location of a user of the device with respect to the portion of the object and compute the location of at least one of the first and second machine readable indicia such that the respective of the first and second relationships comprise the desired physical location.

20. An object comprising:
a first machine readable indicia representative of first information and second machine readable indicia representative of second information different from the first information, such that the first machine readable indicia is perceptible to a device, the device being capable of reading both the first and second machine readable indicia to obtain the first and second information represented thereby, when the device is arranged in a first relationship with respect to the portion of the object and the second machine readable indicia is perceptible to the device when the device is arranged in a second relationship with respect to the portion of the object, the second relationship being different from the first relationship and wherein the second machine readable indicia is not perceptible to the device when the device is arranged in the first relationship and the first machine readable indicia is not perceptible to the device when the device is arranged in the second relationship.
